(19) United States
(12) Patent Application Publication
(10) Pub. No.: US 2026/0340799 A1
(43) Pub. Date: Oct. 29, 2026

(54) AERIAL CABLE TRANSPORT SYSTEM, IN PARTICULAR FOR PASSENGER, WITH CONTROL SYSTEM OF THE CLAMP FOR SELECTIVE COUPLING OF TRANSPORT UNITS TO THE HAULING CABLE

(71) Applicant: LEITNER S.P.A., Vipiteno (IT)

(72) Inventor: Guenter Tschinkel, Vipiteno (IT)

(21) Appl. No.: 19/659,643

(22) Filed: Apr. 27, 2026

(30) Foreign Application Priority Data
Apr. 29, 2025 (IT) 102025000009477

(51) Int. Cl. G06T 7/00; B61B 7/04; B61B 12/02; B61B 12/12; G08B 5/22

(52) U.S. Cl. CPC G06T 7/0002; B61B 7/04; B61B 12/022; B61B 12/122; G08B 5/22; G06T 2207/10016

(57) ABSTRACT

Aerial cable transport system, in particular for passenger. The system comprises: two opposite terminal stations; a hauling cable running between stations; a plurality of transport units; wherein each transport unit comprises a clamp selectively switchable between a closed configuration and an open configuration with the clamp being in the closed configuration outside the stations to couple the corresponding transport unit to the hauling cable and the clamp being in the open configuration inside the stations to release the coupling between the transport unit and the hauling cable. The system also includes a control system of the clamp comprising at least an image capture device and an evaluation unit connected to the evaluation unit. The evaluation unit is configured to analyze the image of the clamp captured by the image capture device and to generate an alarm signal based on the result of this analysis.

### PRIORITY CLAIM

This application claims the benefit of and priority to Italian Patent Application No. 102025000009477, filed on Apr. 29, 2025, the entire contents of which is incorporated by reference herein.

### TECHNICAL FIELD

The technical field of reference of the present disclosure relates to aerial cable transport systems. More specifically, a system of this technical field comprises a plurality of transport units that run in aerial configuration between two terminal stations at opposite ends of the system moved by a hauling cable. Each transport unit comprises a clamp selectively switchable between a closed and an open configuration in which the clamp is in the closed configuration outside the stations to couple the corresponding transport units to the hauling cable and the clamp is in the open configuration inside the stations to release the coupling between the transport units and the hauling cable. In this context, the present disclosure solves certain problems of how to provide the system with a control system of the clamps to check their integrity (i.e., whether all the components are present), correct operation (i.e., whether in a given point the components are in the correct position) and wear (i.e., the state of aging of the components).

### BACKGROUND

An aerial cable transport system, such as one for passenger, is a system in which a plurality of transport units (e.g., gondolas, chairs or both gondolas and chairs in the same system) are moved one after another along a predetermined route. This route is delimited at the opposite ends by two terminal stations for loading and unloading (e.g., mountain and valley stations in mountain systems) and is defined by at least one cable that extends between these stations (usually in two parallel uphill and downhill lines). The “in line” transport speed between the stations is thus defined by the speed of the hauling cable. Between the terminal stations there can be one or more intermediate loading and unloading stations and also (but not necessarily) at least one station for storing transport units when not in line.

In the loading/unloading stations there is the need to advance the transport units at a relatively slower speed with respect to the in-line section to allow passengers to load and unload safely. To avoid slowing down the units travelling outside the stations (i.e., traveling in-line), when the transport units enter the station they are released from the hauling cable and are moved by other devices, such as a plurality of rotating tyres, and supported by specific guide rails. Natu-rally, at the exit from the stations, the transport units couple once again to the hauling cable and continue in aerial configuration.

To allow this selective coupling of the transport units to the hauling cable, each transport unit is provided with a clamp selectively switchable between a closed configuration and an open configuration. The clamp is in the closed configuration outside the stations to couple the corresponding transport unit to the hauling cable. While at least during entry to the station, the clamp is in the open configuration inside the stations to release the coupling between the transport unit and the hauling cable. In particular, at least one spring is provided to force the clamp into the closed configuration while the open configuration is forced in the station by acting on a specific lever of the clamp through a rail along which the clamp advances. This rail is configured to extend along the station such that at entry, it receives the clamp closed and coupled to the cable. During the progressive entry into the station, a rail called “inlet rail” progressively forces the opening lever of the clamp to open its jaws. At this point, the cable is diverted and moves away from the clamp which continues into the station. At the exit from the station the clamp travels along a second rail (e.g., an “outlet rail”) in which the action on the lever is progressively removed and under the force of the spring the clamp returns to the closed position. Before the clamp closes, the hauling cable is once again diverted to be appropriately inserted into the groove of the jaw of the clamp.

It is necessary to check the clamp to verify its integrity, correct operation and wear. These checks are currently carried in different ways. For example, a visual check is carried out by an operator in the station with the purpose of checking the integrity of the clamp (i.e., that all the components of the clamp are correctly present). Another type of check is aimed at checking the condition of wear of the components of the clamp and is carried out by an operator when the system is shut down by appropriate gauge tools on the clamp itself. Another check is linked to correct operation of the clamp (i.e., to the transition from the closed to the open configuration and vice versa). This check is carried out by providing in station, along the inlet and outlet rails, switches actuated by suitable mechanical profiling elements. If at a profiling element the clamp is in the correct configuration, the clamp passes without touching the profiling element which thus does not actuate the corresponding switch. If at a profiling element the clamp is not in the correct configuration, the passing clamp impacts the profiling element and the corresponding switch is actuated to trigger an alarm procedure.

Starting from these practices, an object of the present disclosure is to provide a system to control the clamp that is able to autonomously carry out all at least these checks currently delegated to different methods.

It should be appreciated that while Japanese Patent Document JP 2009 073424 A discloses a device and method for detecting incomplete gripping of a clamp, this system uses a shape measurement sensor as an optical profilometer using a light-cutting method to measure the shape of a cross-section to generate shape data. In JP 2009 073424 A the controller compares the measured shape data with a stored master shape to detect deviations.

### SUMMARY

According to the present disclosure, there is proposed an aerial cable transport system including two terminal stations, a hauling cable running between the terminal stations, and a transport unit. The transport unit includes a clamp selectively switchable between: (i) a closed configuration outside each of the terminal stations to couple the transport unit to the hauling cable, and (ii) an open configuration inside each of the terminal stations to release a coupling between the transport unit and the hauling cable. The aerial cable transport system also includes a control system associated with the clamp which includes an image capture device arranged at a control point such that when the transport unit passes by the control point, the clamp of the transport unit is in a capture range of the image capture device and the image capture device captures an image of the clamp, and an evaluation unit connected to the image capture device such that the image of the clamp captured by the image capture device is transmitted to the evaluation unit which is configured to analyze the image of the clamp captured by the image capture device and generate an alarm signal based on a result of this analysis.

In certain embodiments, the system of the present disclosure comprises at least two terminal stations at opposite ends of the system in which passenger may load and unload. In certain such embodiments the stations are U-shaped in plan to produce two parallel lines of the system (e.g., uphill line and downhill line in mountain systems). The system of these embodiments further includes a hauling cable running between stations in which the system can be a single cable system with only the hauling cable that also acts as support cable or one or two support cables can also be provided in addition to the hauling cable. The hauling cable of certain embodiments is a closed loop cable driven by pulleys (one of which is motorized) installed in the terminal stations. The system of these embodiments also includes a plurality of transport units, (e.g., chairs, gondolas or both chairs and gondolas) in which passengers are transported between the terminal stations where loading and unloading takes place. In certain embodiments, each transport unit comprises a clamp selectively switchable between a closed and an open configuration. The clamp is in the closed configuration outside the stations and couples the corresponding transport unit to the hauling cable. While at the entry to the stations, the clamp is forced into the open configuration to release the coupling between the transport unit and the hauling cable.

In certain embodiments, the system includes a control system of the clamp of an automatic and autonomous type (i.e., capable of generating an alarm signal also with no operator present). In these embodiments, the control system comprises at least an image capture device and an evaluation unit. Each image capture device is arranged at a corresponding control point along the system, such that when the transport unit passes by the control point, the corresponding clamp is in the image capture range of the image capture device and the image capture device captures at least one image (and/or a video) of the clamp. Each image capture device is connected to the evaluation unit such that the at least one image of the clamp captured by the image capture device is transmitted to the evaluation unit. The evaluation unit is configured to analyze the image of the clamp captured by the image capture device and to generate an alarm signal based on the result of this analysis.

In certain embodiments, a first type of analysis performed by the evaluation unit is aimed at checking the integrity of the clamp (i.e., whether all components of the clamp are present) and to generate an alarm signal if at least one component is missing. This first type of analysis enables the current practice, which requires a visual check carried out in station by an operator, to be automated or integrated.

In certain embodiments, a second type of analysis performed by the evaluation unit is aimed at verifying whether at the control point the clamp is effectively in the correct configuration. Correct configuration is meant both as whether the clamp is open or closed where required, and whether it is raised due to presence of snow between clamp and support. To perform this analysis, the evaluation unit is provided in the memory with a virtual image of the clamp that reproduces the correct configuration that the clamp should have at the control point and performs a comparison between the image of the clamp captured by the image capture device and the aforesaid virtual image. In particular, this comparison is carried out by superimposition of the image of the clamp captured by the image capture device with the virtual image of the clamp and an alarm signal is generated if the actual image of the clamp does not coincide with the virtual image of the clamp (e.g., if it exceeds the edge of the virtual image of the clamp in at least one point). This second type of analysis enables the current practice, which requires the presence of mechanical profiling element with a switch arranged along the system that are impacted by the clamp at that point if it is in an incorrect configuration, to be automated or integrated.

In certain embodiments, a third type of analysis performed by the evaluation unit is aimed at checking the wear of the components of the clamp. This analysis is also performed by superimposition of the image of the clamp captured by the image capture device with the virtual image of the clamp and the distance between the edges of the actual image of the clamp and of the virtual image of the clamp is controlled. If this distance exceeds a threshold value, an alarm signal is generated. This third type of analysis enables the current practice, which requires the use of manual tools, to be automated or integrated.

It should be appreciated that the alarm signal can be implemented in various ways. In various embodiments, the alarm signal is one or more of a visual light signal, an acoustic signal, stopping of the system and/or transmission of the notification of the generation of this alarm to an operator in one of the stations or transmission to a remote location.

In certain embodiments, the image capture device includes a video camera or any other equivalent device. In certain embodiments, at least one image capture device is at a location to capture at least one image of the clamp when the transport unit is outside the stations and/or at least one image capture device is at a location to capture at least one image of the clamp when the transport unit is inside the stations.

In certain embodiments, a display device connected to the evaluation unit and configured to display the outcome of the analysis conducted by the evaluation unit is present in one of the stations or in a remote position. In certain such embodiments, the display device is configured to display the superimposition of the actual image of the clamp with a virtual image of the clamp to enable an operator to visually check the correct outcome of the analysis conducted by the evaluation unit.

### BRIEF DESCRIPTION OF THE DRAWINGS

For a better understanding of the present disclosure an embodiment will now be described purely by way of non-limiting example, with reference to the accompanying drawings, wherein:

FIG. 1 is a schematic view of an aerial cable transport system;

FIG. 2 is an enlarged schematic view of the detail indicated with II in FIG. 1;

FIGS. 3 and 4 are views of a component of the system of FIG. 1 that show an example of a clamp that represents the element controlled according to certain embodiments of the present disclosure; and

FIGS. 5 and 6 show an example embodiment of the present disclosure in which the clamp is controlled by a control system and the outcome of this control is displayed on a specific screen for a possible visual check by an operator in station or in a remote location.

### DETAILED DESCRIPTION

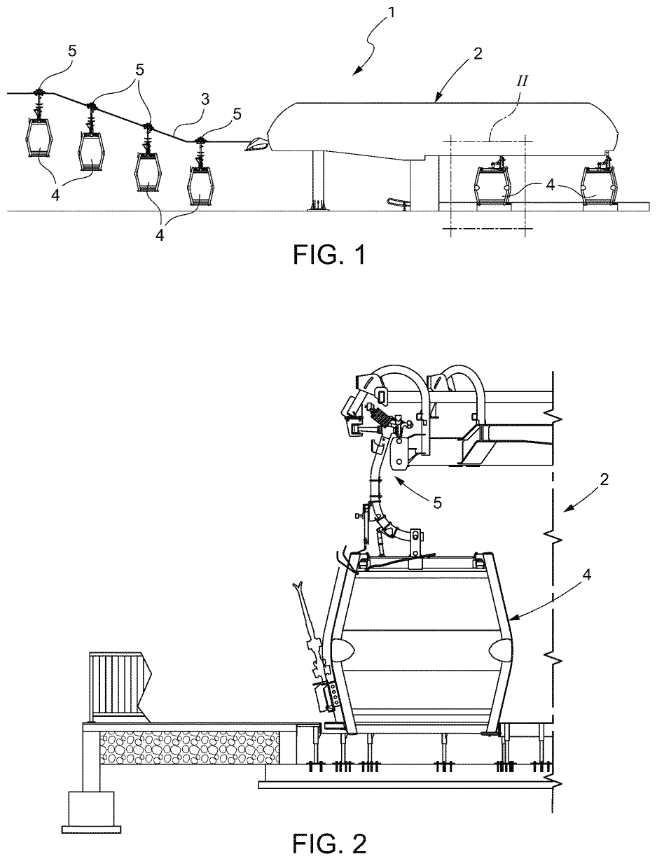

FIG. 1 is a schematic view of an aerial cable transport system which can be im-proved in accordance with the present disclosure. In particular, in FIG. 1 a portion of a system 1 (i.e., a terminal station 2, a hauling and support cable 3 and a plurality of gondolas 4) is visible. As can be seen, outside the station 2, the gondolas 4 are coupled to the hauling cable 3 through a clamp 5 at the upper end of a suspension arm connected below to the roof of the corresponding gondola. For the purposes of the present disclosure, reference is made to systems with “at least one cable”, but the number of cables present is not a limiting feature. In other words, according to the present disclosure, the system includes only the hauling cable (which performs both the function of support cable and of hauling cable and is moved in a loop between the stations) or the system includes one or two fixed (unmoving) support cables and one hauling cable.

FIG. 2 is an enlarged schematic view of the detail indicated with II in FIG. 1 and shows a gondola 5 inside the station 2. At the entry to the station, the coupling of the cable 3 to the clamp 5 is released. In particular, the clamp is opened and the gondola advances thrust by motorized wheels that act as advancing device in place of the cable. In particular, as can be seen in FIG. 2, some rollers of the clamp collaborate with specific rail guides or rails. The configuration and the extension of these rails along the station is variable and imparts specific movements to movable components of the clamp to open it at the entry to the station and close at the exit from the station.

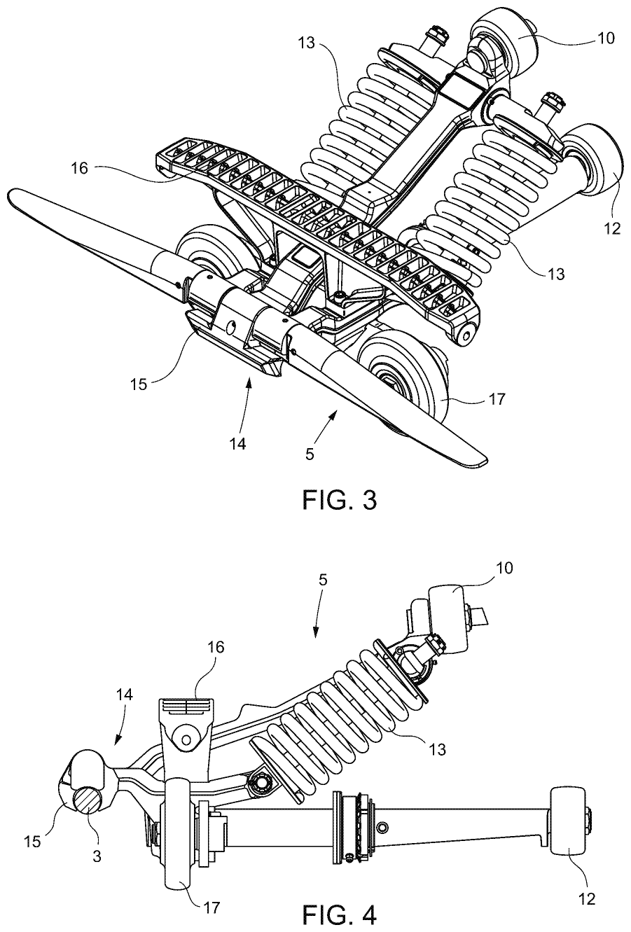

FIGS. 3 and 4 show an example of a clamp that represents the element controlled in accordance with the present disclosure. In this example, the clamp 5 comprises a handling roller 10 that runs on the inlet and outlet rails in the station to control coupling and release of the cable 3 through opening and closing of the jaw, a guide roller 12 through which the clamp (and hence the gondola) is held and supported in the station 2, springs 13 that force the clamp into the closed configuration, a clamp body 14 with a movable jaw 15 controlled by the handling roller 10, a knurled shoe 16 on which the motorized wheels for advancing in the station 2 act, sliding rollers 17. In FIG. 3 the cable 3 is also schematized for clarity.

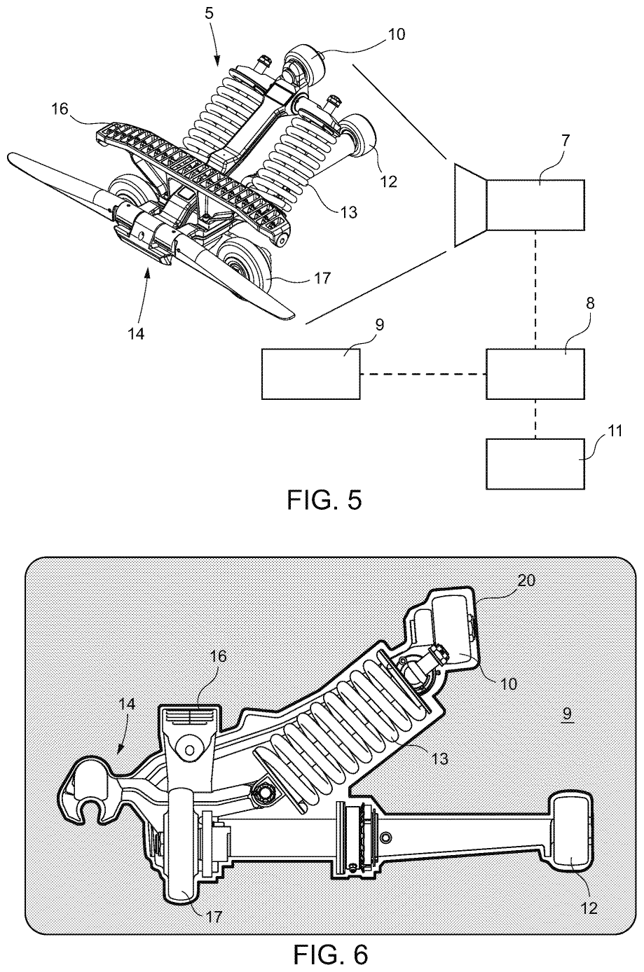

FIGS. 5 and 6 show an example of embodiment of the present disclosure in which the clamp 5 is controlled by the control system. The reference numbers 7 8 and 9 schematize a camera 7 installed along the system 1 at a control point in which it is of interest to control the clamp 5. Numerous cameras 7 can be present in the system 1 at corresponding control points and the camera itself is an example of an image capture device.

In these embodiments, when the clamp 5 transits at the control point, the camera 7 captures one or more images of the clamp 5 and transmits this image (or these images) to an evaluation or control unit 8 (of control unit with calculation capacity type). This evaluation unit 8 is configured to perform several analyses of the images received, in particular it checks whether all the components of the clamp 5 are present with respect to a list saved in the unit 8 and whether the components of the clamp 5 are in the correct configuration (e.g., whether the jaw is open or closed with respect to an indication saved in the unit 8 regarding the correct configuration that must be implemented at the control point). Moreover, the unit 8 checks the condition of wear of the components of the clamp 5 (e.g., the condition of the rollers 10, 12 and 17). In certain embodiments, these checks are performed by the unit 8 by superimposition of the image of the clamp 5 received from the camera 7 with a virtual image of the clamp (saved in the unit 8) that represents the correct configuration that the clamp should have at the control point. In operation, the unit 8 compares the actual image of the clamp with the contour of the virtual image, and based on the result of this comparison, controls one or more alarm devices 11 (which can be visual, acoustic, etc.) or can control shutdown of the system. The outcome of this check and the superimposition of the actual image of the clamp 5 with the edge 20 of the virtual image can also be transmitted to a display device 9 to enable an operator, such as in the station 2 or located remotely, to verify the analysis conducted by the unit 8. FIG. 6 schematically represents this display device 9 in the case of a check with a positive outcome in which the clamp 5 does not exceed an edge 20 defined by the virtual image of the clamp in its correct configuration at the control point in any point.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Finally, it is clear that modifications and variations can be made to the system described and illustrated without departing from the scope of protection of the present disclosure, as defined in the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention is claimed as follows:

1. An aerial cable transport system comprising:
two terminal stations;
a hauling cable running between the terminal stations;
a transport unit comprising a clamp selectively switchable between: (i) a closed configuration outside each of the terminal stations to couple the transport unit to the hauling cable, and (ii) an open configuration inside each of the terminal stations to release a coupling between the transport unit and the hauling cable; and
a control system associated with the clamp and comprising:
an image capture device arranged at a control point such that when the transport unit passes by the control point, the clamp of the transport unit is in a capture range of the image capture device and the image capture device captures an image of the clamp; and
an evaluation unit connected to the image capture device such that the image of the clamp captured by the image capture device is transmitted to the evaluation unit which is configured to analyze the image of the clamp captured by the image capture device and generate an alarm signal based on a result of this analysis.

2. The aerial cable transport system of claim 1, wherein the evaluation unit is configured to:
check whether all components of the clamp are present, and
generate the alarm signal if at least one component of the clamp is missing.

3. The aerial cable transport system of claim 1, wherein the evaluation unit is configured to:
compare the image of the clamp captured by the image capture device with a virtual image of the clamp corresponding to a correct configuration that the clamp should have at the control point, and
generate the alarm signal based on a result of this comparison.

4. The aerial cable transport system of claim 3, wherein the evaluation unit is configured to:
compare, by superimposition, the image of the clamp captured by the image capture device with the virtual image of the clamp corresponding to the correct configuration that the clamp should have at the control point, and
generate the alarm signal if the image of the clamp captured by the image capture device exceeds an edge of the virtual image of the clamp at at least one point.

5. The aerial cable transport system of claim 3, wherein the evaluation unit is configured to:
compare, by superimposition, the image of the clamp captured by the image capture device with the virtual image of the clamp corresponding to the correct configuration that the clamp should have at the control point, and
generate the alarm signal if the image of the clamp captured by the image capture device does not exceed a contour of the virtual image of the clamp and a distance between a point of the image of the clamp captured by the image capture device and an edge of the virtual image of the clamp is greater than a threshold value.

6. The aerial cable transport system of claim 1, wherein the image capture device comprises a video camera.

7. The aerial cable transport system of claim 1, wherein the image capture device is arranged at a location such that the image of the clamp is captured when the transport unit is outside each of the terminal stations.

8. The aerial cable transport system of claim 1, wherein the image capture device is arranged at a location such that the image of the clamp is captured when the transport unit is inside one of the terminal stations.

9. The aerial cable transport system of claim 1, wherein the control system associated with the clamp further comprises a display device connected to the evaluation unit and configured to display an outcome of the analysis of the evaluation unit.

10. The aerial cable transport system of claim 9, wherein the display device is configured to display a superimposition of the image of the clamp captured by the image capture device with a virtual image of the clamp.

11. A method of operating an aerial cable transport system, the method comprising:
capturing, through an image capture device, an image of a clamp of a transport unit at a control point along the aerial cable transport system comprising two end stations, a hauling cable running between the end stations, and the transport unit, wherein the clamp of the transport unit is selectively switchable between: (i) a closed configuration outside each of the end stations to couple the transport unit to the hauling cable, and (ii) an open configuration inside each of the end stations to release a coupling between the transport unit and the hauling cable;
analyzing, through an evaluation unit, the image of the clamp captured by the image capture device; and
determining, based on the analysis of the image of the clamp, whether to generate an alarm signal.

12. The method of claim 11, wherein analyzing the image of the clamp comprises checking whether all components of the clamp are present.

13. The method of claim 11, wherein analyzing the image of the clamp comprises comparing the image of the clamp captured by the image capture device with a virtual image of the clamp corresponding to a correct configuration that the clamp should have at the control point.

14. The method of claim 13, wherein analyzing the image of the clamp comprises superimposing the image of the clamp captured by the image capture device with the virtual image of the clamp corresponding to the correct configuration that the clamp should have at the control point; and further comprises generating the alarm signal if at least one of: a point of the image of the clamp captured by the image capture device exceeds an edge of the virtual image of the clamp and when the image of the clamp captured by the image capture device does not exceed the edge of the virtual image of the clamp, a distance between a point of the image of the clamp captured by the image capture device and the edge of the virtual image of the clamp is greater than a threshold value.

15. The method of claim 11, wherein capturing the image of the clamp occurs when the transport unit is outside one of the end stations.

16. The method of claim 11, further comprising displaying, via a display device connected to the evaluation unit, an outcome of the analysis of the evaluation unit.

17. The method of claim 16, wherein the display comprises a superimposition of the image of the clamp captured by the image capture device with a virtual image of the clamp.
